(19) United States
(12) Patent Application Publication
(10) Pub. No.: US 2026/0050304 A1
(43) Pub. Date: Feb. 19, 2026

(54) DATA CENTER COOLING

(71) Applicant: Dropbox, Inc., San Francisco, CA (US)

(72) Inventors: Eric Shobe, Kihei, HI (US); Vishal Jose Mannanal, Renton, WA (US); Sandeep Kumar R. Ummadi, Issaquah, WA (US); Latane Garetson, San Jose, CA (US); Tsung-Hsiang Chang, Bellevue, WA (US); Eddie del Rio, Alamo, CA (US)

(21) Appl. No.: 18/808,620

(22) Filed: Aug. 19, 2024

(51) Int. Cl. G06F 1/20; G06F 13/20; G06N 5/022

(52) U.S. Cl. CPC G06F 1/20; G06F 13/20; G06N 5/022

(57) ABSTRACT

The present technology pertains to a predictive thermal model that can be used to intelligently manage thermal events in a data center. The predictive thermal model can be used to predict future temperatures of servers to take action before the server experiences higher than desired temperatures. The present technology also includes several innovative amelioration techniques that can help to keep servers cool when it is predicted that heat in their environment is about to increase. One such amelioration technique is a heat-responsive operation change for storage servers, or at least individual hosts within a storage server. For example, a host can be switched into a mode where it can batch read and write operations to limit the amount of seeking the host needs to perform, which produces less heat.

### BACKGROUND

Organizations are presently using cloud-based storage systems to store large volumes of data. These cloud-based storage systems are typically operated by hosting companies that maintain a sizable storage infrastructure, often comprising thousands of servers that are sited in geographically distributed data centers. Customers typically buy or lease storage capacity from these hosting companies. In turn, the hosting companies provision storage resources according to the customers' requirements and enable the customers to access these storage resources.

Tenants in these data centers are naturally concerned with the environment that the data center provides, which includes access to reliable power, lower likelihood of natural disasters, and adequate cooling capacity, among other factors. Whether the data center houses servers primarily used for storage, compute, or acceleration, these factors are important to keeping tenant devices or workloads operating efficiently.

In the case of storage servers, host manufacturers recommend operating temperatures between 5° C. and 60° C.; however, excessive heat can cause drives to fail prematurely. In fact, studies have shown that drives running hotter over time tend to experience higher failure rates compared to cooler drives.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates a conceptual diagram of sources data in a data center used to train a predictive thermal model in accordance with some embodiments of the present technology.

FIG. 2 illustrates an example system for using outputs from the predictive thermal model in accordance with some embodiments of the present technology.

FIG. 3 illustrates an example routine for causing a hard drive to operate in a second I/O operational mode in response to a prediction from the predictive thermal model in accordance with some embodiments of the present technology.

FIG. 4A and FIG. 4B illustrate a comparison between a default I/O operational mode and the second I/O operational mode in accordance with some embodiments of the present technology.

FIG. 5 illustrates an example routine for causing at least one operational change in a data center in response to a prediction that a POD will experience temperatures above a threshold in accordance with some embodiments of the present technology.

FIG. 6 illustrates controlling a vent to increase its aperture to direct additional cold air into the POD in accordance with some embodiments of the present technology.

FIG. 7 illustrates controlling a datacenter computer room air conditioner unit (CRAC) to shift airflow to cool a POD in accordance with some embodiments of the present technology.

FIG. 8 illustrates an example routine for directing workloads away from at least one server within the POD that is predicted to be hot to at least one server in a second POD that is predicted to be cool in accordance with some aspects of the present technology.

FIG. 9 illustrates moving a workload from a server that is hot or a server in a POD that is hot, to a cooler server or a server in a cooler POD in accordance with some embodiments of the present technology.

FIG. 10 illustrates predicting that a first server is located near servers utilized by another tenant of the data center, which generates higher than average amounts of heat in accordance with some embodiments of the present technology.

FIG. 11 illustrates an example routine for reallocating workloads away from servers having degraded power key performance indicator (KPI) in accordance with some embodiments of the present technology.

FIG. 12 illustrates an example routine for allocating workloads to make more efficient use of a power supply in accordance with some embodiments of the present technology

FIG. 13 illustrates an example of even utilization of a three-phase power supply in accordance with some embodiments of the present technology.

FIG. 14 illustrates an aspect of the subject matter in accordance with one embodiment.

FIG. 15 shows an example of a system for implementing certain aspects of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Organizations are presently using cloud-based storage systems to store large volumes of data. These cloud-based storage systems are typically operated by hosting companies that maintain a sizable storage infrastructure, often comprising thousands of servers that are sited in geographically distributed data centers. Customers typically buy or lease storage capacity from these hosting companies. In turn, the hosting companies provision storage resources according to the customers' requirements and enable the customers to access these storage resources.

Tenants in these data centers are naturally concerned with the environment that the data center provides, which includes access to reliable power, lower likelihood of natural disasters, and adequate cooling capacity, among other factors. Whether the data center houses servers primarily used for storage, compute, or acceleration, these factors are important to keeping tenant devices or workloads operating efficiently.

In the case of storage servers, host manufacturers recommend operating temperatures between 5° C. and 60° C.; however, excessive heat can cause drives to fail prematurely. In fact, studies have shown that drives running hotter over time tend to experience higher failure rates compared to cooler drives.

Unfortunately, tenants having servers in a data center have a limited ability to adequately manage their devices within the data center since tenants are generally limited to information about their devices and workloads. This means that while tenants can learn of servers that are experiencing higher than desired temperatures, a tenant's main recourse is to move workloads to other devices. However, such management is both reactive, occurring after a server is already experiencing higher temperatures, and is done without knowledge of nearby servers from other tenants. If the nearby servers of other tenants are generating significant heat, moving the workload might not solve the problem if that server is soon to experience higher than desired temperatures.

The present invention addresses specific problems related to thermal management in cloud-based storage systems, particularly those arising from hot operating conditions in data centers or server enclosures.

More specifically, the present technology pertains to a predictive thermal model that can be used to intelligently manage thermal events in a data center. The predictive thermal model can be used to predict future temperatures of servers to take action before the server experiences higher than desired temperatures. This can achieve one goal of the present technology, which is to protect servers from experiencing higher than desired temperatures thereby limiting heat-accelerated failure rates.

The predictive thermal model can learn information from devices under the control of the tenant and, from such data points, can infer information about the data center environment, such as when a nearby tenant might be contributing to a hotter-than-desired environment. Therefore, when it is desired to allocate workloads to servers that currently are experiencing normal or cool temperatures, servers can be chosen that are not likely to be nearby a tenant that is about to generate significant heat.

In addition to the inventive predictive thermal model, the present technology also includes several innovative amelioration techniques that can help to keep servers cool when it is predicted that heat in their environment is about to increase. One such amelioration technique is a heat-responsive operation change for storage servers, or at least individual hosts within a storage server. As will be addressed below, a host can be made to sacrifice the speed of I/O operations to generate less heat. For example, a host can be switched into a mode where it can batch read and write operations to limit the amount of seeking the host needs to perform, which produces less heat.

The present technology can also send requests to a tenant data center controller to adjust cooling airflow to the cabinet or POD that contains a server that is predicted to experience higher than desired temperatures.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

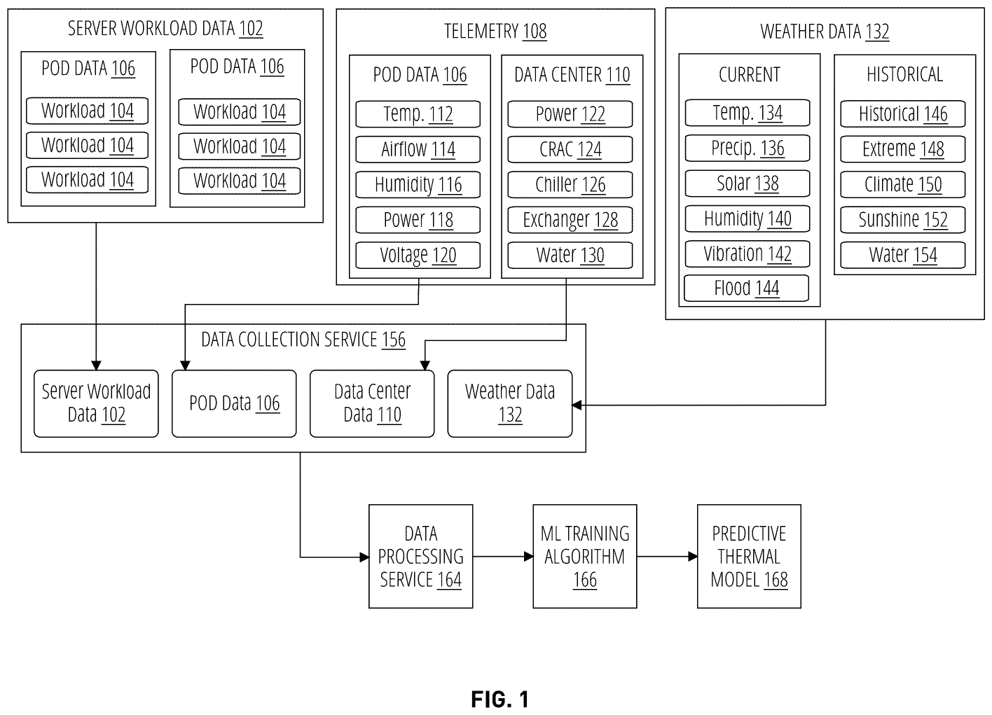

FIG. 1 illustrates a conceptual diagram of sources data in a data center used to train a predictive thermal model in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

FIG. 1 illustrates three main sources of data: server workload data 102, telemetry 108, and weather data 132 for use in training the predictive thermal model 168 of the present technology.

Server workload data 102 consists of server workload data 104 that is reported from POD data 106 (Performance Optimized Datacenter) within the data center. PODs are standardized, self-contained units that house a specific set of data center resources, including racks, servers, storage, networking hardware, and supporting infrastructure such as power and cooling systems. Referring more particularly to the servers within the POD data 106, the servers are tasked with workloads (such as compute or storage or acceleration tasks depending on the type of server. Thus, servers within the respective PODs report server workload data 104 to be stored as server workload data 102 by the data collection service 156. The server workload data 102 can include data collected to evaluate the performance and reliability of servers and drive workloads. It includes metrics such as Random Read/Write IOPS (Input/Output Operations Per Second) and Sequential Read/Write IOPS, which measure the efficiency of data handling under different types of access patterns. Temperature readings are recorded at various intervals (−10 mins, −5 mins, −1 min, −30 secs, −1 sec) to monitor thermal stability over time. The type of drive (SSD or HDD) and specific attributes like HDD RPM provide insight into the hardware configuration. Reliability and durability are assessed through SMART (Self-Monitoring, Analysis, and Reporting Technology) attributes, which help predict potential drive failures. Additionally, power consumption is tracked to understand the energy usage of the drives, contributing to overall system efficiency analysis.

In the case of storage servers, the servers can include a plurality of hard drives and a host that is responsible for managing the hard drives within the server. For example, a host can initiate read/write requests, allocate and deallocate storage space, buffering data for I/O operations, monitor key performance indicators (KPIs) such as temperature readings and power consumption, etc.

Telemetry 108 is measured from at least two main sources: PODs and the data center. Some example types of telemetry 108 that can be received from PODs include data on temperature 112, airflow 114, humidity 116, power 118, and voltage 120. Similarly, the data center can provide telemetry 108 on power 122, CRAC 124 (Computer Room Air Conditioning), chiller 126, exchanger 128, and water 130. This comprehensive range of telemetry sources illustrates the breadth of data collected for the predictive thermal model.

Another data source includes current and historical weather-related data. For example, the weather data 132 data includes current temperature 134, precipitation 136, solar 138, humidity 140, vibration 142, and flood 144 condition data. It also includes historical values 146 for temperature, precipitation, solar, humidity, vibration, and flood condition data. Other historical data includes data about extreme 148 temperature values, climate averages 150 (e.g., average temperature, humidity, and rainfall, etc.), sunshine 152 (e.g., number of sunny days per month or year), and water availability 154 (e.g., reservoir levels, water table levels, drought conditions, etc.).

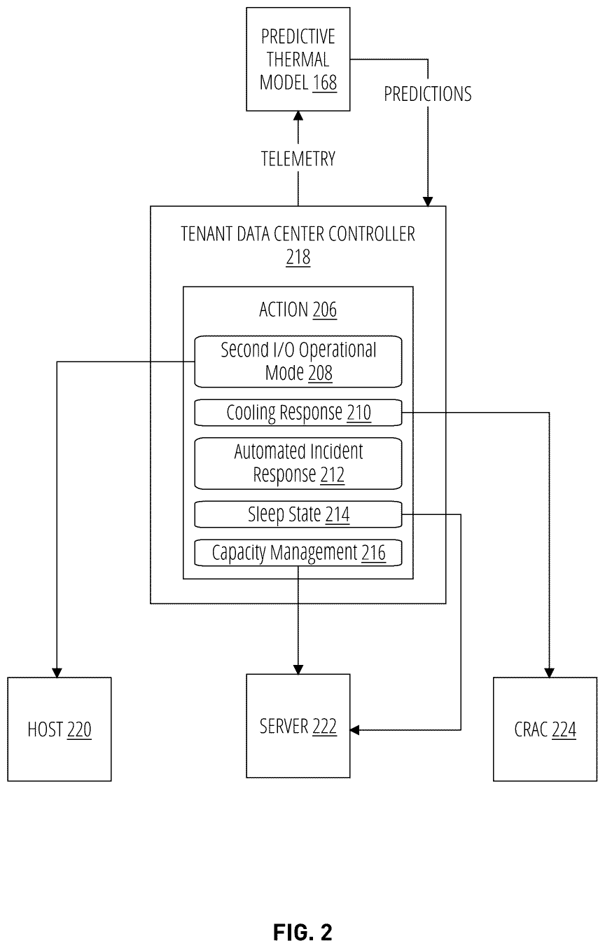

As illustrated in FIG. 1 the server workload data 102, POD data 106, data center data 110, and weather data 132 are collected by data collection service 156. Data processing service 164 takes months of historical data consisting of all aforementioned data as the inputs, converts them into numerical features, and feeds the features into an ML training algorithm 166 to produce a predictive thermal model 168. The predictive thermal model 168 can be a Recurrent Neural Network or Transformer, for predicting a drive-level temperature time series. The predicted temperatures can be used in a decision model (which can be a ML model or heuristics) to take appropriate actions (addressed in FIG. 2) to prevent overheating.

In some embodiments, the predictive thermal model can predict future temperatures of a drive, a server, and/or a POD. In some embodiments, rather than predict a future temperature, the predictive thermal model can predict that a drive, a server, and/or a POD will experience higher than desired temperatures at the future time. In other words, it isn't necessary to predict a particular temperature as much as it is to predict that a drive, server, and/or POD will be hotter than desired.

In some embodiments, the predictive thermal model can be specific to a tenant of a data center. For example, when a tenant of a data center is just one of several tenants, the tenant might have limited control of certain factors, such as controlling a CRAC, or choosing where their servers are located in the data center. In such embodiments, the predictive thermal model can utilize any information available to the tenant to make predictions regarding temperatures of disks, servers, PODs, etc, and a decision model can output decisions that can be implemented by the tenant (shifting workloads, changing operational states of servers or disks, putting servers into a sleep state, controlling floor vent apertures for a POD, etc.).

In some embodiments, the predictive thermal model 168 can be made up of more than one model or algorithm. Likewise the decision model can be made up of more than one model or algorithm.

FIG. 2 illustrates an example system for using outputs from the predictive thermal model in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

As illustrated in FIG. 2, predictive thermal model 168 can output predictions based on telemetry received from tenant data center controller 218. The tenant data center controller 218 can be a device or an application used to manage tenant devices (or utilization of devices when a device is co-tenanted).

A prediction can include predicted temperatures for individual servers or hard drives at a plurality of future times, such as in 30 seconds, 1 minute, 5 minutes, 10 minutes, 30 minutes, 1 hour, 12 hours, etc., or can be a time series graph showing predicted temperatures extending some period into the future.

The tenant data center controller 218 can utilize such predictions to take one or more actions 206. Some actions, such as those that affect hosts 220 or servers 222 can be effected by tenant data center controller 218 since those devices are under the control of the tenant data center controller 218. Other actions might be subject to making requests of other systems that are not directly under the control of tenant data center controller 218. For example, if a CRAC 224 is under the control of a data center operator, it might be that tenant data center controller 218 can make a request to adjust cooling for one or more PODs or areas around a server, but the response to such a request is up to the data center operator.

As will be described further herein, one type of action 206 can be to put a particular hard drive into a second I/O operational mode 208, other than its default state. The second I/O operational mode 208 might be less performant at responding to I/O requests but would result in less heat generation. The second I/O operational mode 208 can be directed at a particular host 220 for a particular storage device.

Another type of action 206 can be to manage a server 222 to go into sleep state 214 to avoid operating at a temperature that is higher than desired, or to shift workloads (capacity management 216) away from a server that is projected to be operating in an environment that is warmer than desired.

Another type of action 206 can be to influence a cooling response 210. In some embodiments, the cooling response 210 can be under control of the tenant data center controller 218, such as when a POD has adjustable vents or floor tiles that can be adjusted to increase or decrease airflow into and around the POD. In some embodiments, the cooling response 210 is under control of a CRAC 224 controlled by the data center, in which case the cooling response 210 is to request increased cooling from the CRAC 224.

In some embodiments, the action 206 can be to institute an automated incident response 212. For example, and automated incident response can be a severity incident response that is categorized based on impact and urgency. Critical incidents, such as complete server failures or security breaches, require immediate team notification, disaster recovery activation, and data restoration. High-severity issues, like significant performance degradation, demand swift technical support intervention and potential data recovery. Medium-severity incidents involve addressing non-critical hardware failures or configuration errors during scheduled maintenance. Low-severity issues include routine maintenance alerts handled with regular monitoring and documentation. Informational alerts, like routine health checks, are logged and reviewed for trends without requiring immediate action.

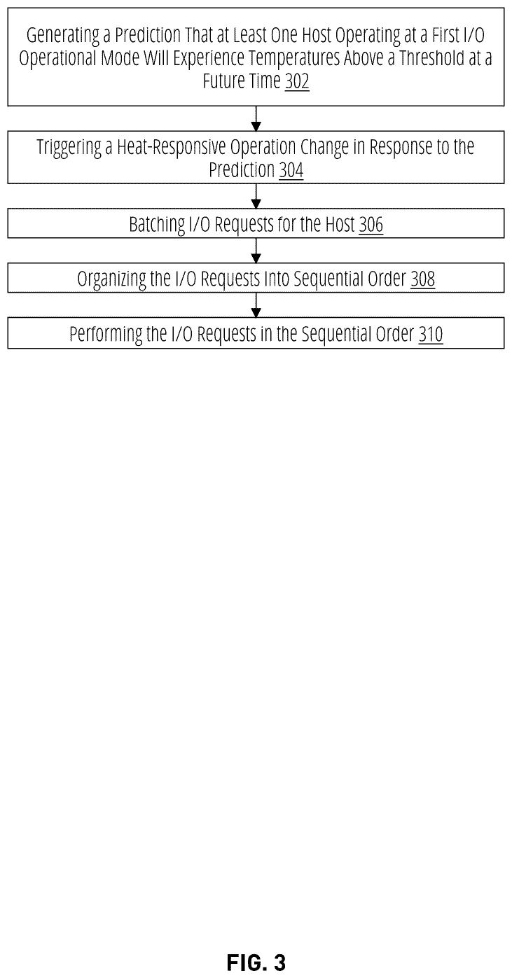

FIG. 3 illustrates an example routine for causing a hard drive to operate in a second I/O operational mode in response to a prediction from the predictive thermal model in accordance with some embodiments of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

In some embodiments, the second I/O operational mode can be any change in the operation of a server or hard drive that proactively prevents the server or hard drive from shutting down due to excessive temperatures. As addressed below, one example of the second I/O operational mode is to operate with less seek operations. In some instances the hard drive can reduce seek operations by batching and ordering I/O requests. Another example of second I/O operational mode is to operate a hard drive by spinning a disk a lower rotations per minute (RPM). Another example of second I/O operational mode is to move a head of a hard drive less, which can involve less I/O operations or operating with less seek operations. Another example of second I/O operational mode is to allocate workloads that have less I/O operations to hotter hard drives to allow them to cool. The second I/O operational mode can be any of the above or a combination of the above techniques.

By operating the server or hard drive in the second I/O operational mode, it may be possible to proactively keep a hard drive from exceeding a desired temperature, which can increase the reliability and longevity of the hard drive. The second I/O operational mode may also allow for more hard drives to be installed in the same server enclosure by proactively managing the temperature within the enclosure through selectively operating some hard drives in the second I/O operational mode.

FIG. 3 addresses the example of the second I/O operational mode by reducing seek operations by batching and ordering I/O requests, however, it should be appreciated that alternated second I/O operational modes can be used or can be used in combination with a second I/O operational mode that reduces seek operations by batching and ordering I/O requests.

According to some examples, the method includes generating a prediction that at least one host operating at a first I/O operational mode will experience temperatures above a threshold at a future time at block 302. For example, the predictive thermal model 168 illustrated in FIG. 2 may generate a prediction that at least one host operating at a first I/O operational mode will experience temperatures above a threshold at a future time.

As addressed above, the predictive thermal model is trained to predict the temperature of a host or even a particular hard drive within at least one server. The prediction can be a time series that includes at least two future times, a first future time, and a second future time, wherein the first future time is less than a minute from the prediction, and the second future time is greater than a minute from the prediction. For example, a time series might predict the temperature of the host or hard drive 30 seconds into the future and also at an additional time in the future such as 1-minute, 10-minutes, 30-minutes, 1-hour, 3-hours, 6-hours, etc. into the future. Although specific periods are listed, persons of ordinary skill in the art will understand that the period can be any value, and further, that a time series can include predictions of any period that is encompassed within the time series (i.e., a time series from present to 10 minutes, can show the predicted temperature at any interval within 10 minutes).

According to some examples, the method includes triggering a heat-responsive operation change in response to the prediction at block 304. For example, the tenant data center controller 218 illustrated in FIG. 2 may trigger a heat-responsive operation change in response to the prediction. The heat-responsive operation change causes the host to operate in a second I/O operational mode, which generates less heat (e.g., on average) than the first I/O operational mode.

In some embodiments, the second I/O operational mode includes causing a hard drive to operate with less seek operations as will be addressed in greater detail with respect to block 306, block 308, and block 310. Generally, in a first I/O operational state, a host for a storage server will receive an I/O request and will cause a hard drive to perform the requested read or write operation in the order in which the requests are received. The hard drive will need to seek to the correct addressing location on the hard drive to perform the read or write, and will do this in the order in which the I/O operation was received. This means that the hard drive might need to seek all the way to the outside track of the disk within the hard drive for a first I/O operation, then to the inside track of the hard drive for a second I/O operation, and then back to the outside track of the hard drive for the third I/O operation. This results in a lot of mechanical movement and can generate a lot of heat due to the increased power consumption used to move the head. In contrast, the present technology can order those I/O operations so that the first and third I/O operations can be performed together, resulting in less movement of the hard drive head. Thus, the hard drive performs less seek operations to handle the I/O requests in the second I/O operational mode than in the first I/O operational state. Said another way, the second I/O operational mode results in fewer seek operations per second than the first I/O operational state.

For example, the method includes batching I/O requests for the host at block 306. For example, the host 220 illustrated in FIG. 2 may batch I/O requests for the hard drive.

According to some examples, the method includes organizing the I/O requests into sequential order at block 308. For example, the host 220 illustrated in FIG. 2 may organize the I/O requests into sequential order. According to some examples, the method includes performing the I/O requests in the sequential order at block 310. For example, the host 220 illustrated in FIG. 2 may cause the hard drive to perform the I/O requests in the sequential order.

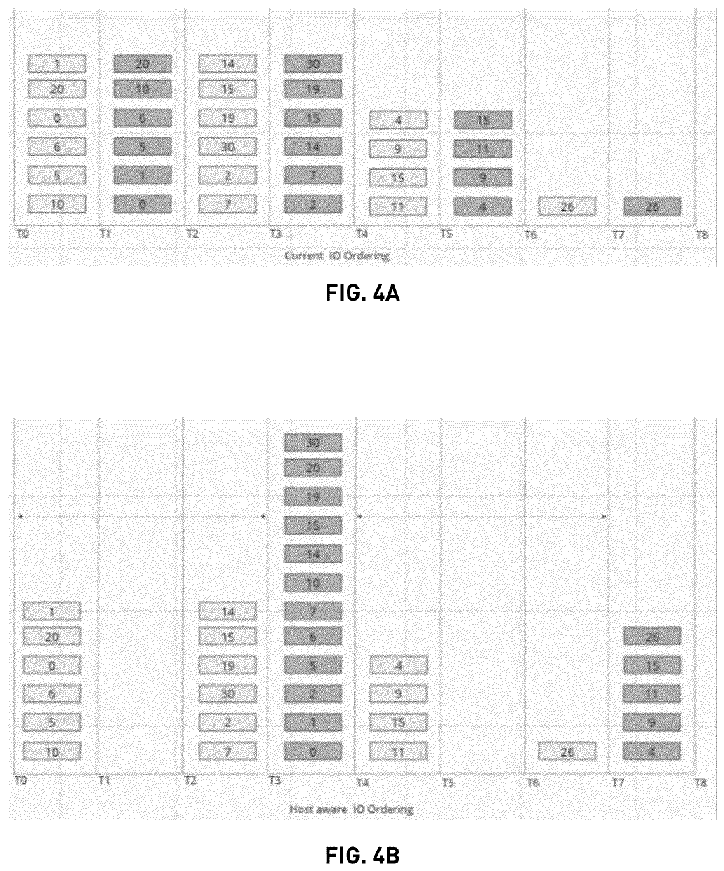

FIG. 4A and FIG. 4B illustrate a comparison between a default I/O operational mode and the second I/O operational mode in accordance with some embodiments of the present technology.

In FIG. 4A I/O requests are received at T0, T1, T2, 43, T4, T5, T6, . . . and are ordered as they are received.

In FIG. 4B, the host initiates I/O reordering to mitigate power-hungry seeks across logical block addresses on a hard drive. For example, I/O requests are batched together and submitted in sequential order at T3 and T7, thereby minimizing the need for power-hungry seeks and reducing the drive's thermal stress. More specifically I/O requests received at T1 have been batched and are joined with I/O requests received at T3. In addition to being batched, they have been re-ordered to be sequential so that the drive can perform the I/O operations in a way that makes the seeking across the hard drive more efficient.

By implementing the second I/O operational mode that optimizes seeking on hard drives, numerous benefits can be realized. By streamlining the seeking process, power consumption can be minimized, prolonging the lifespan of the drives and reducing the risk of failure. The use of this second I/O operational mode can lead to improved overall system efficiency, reduced energy consumption, and extended drive longevity. And since hard drives will fail less often, data integrity is improved because there is less risk of data loss. Additionally, hard drives can be proactively managed to stay within a safe operating temperature range without fear or a reactionary shut down in response to a high temperature of a hard drive.

In some embodiments, other operational changes can be performed in addition to, or as an alternative to the second I/O operational mode. For example, when a hard drive has been operating in an undesirable temperature range for a period, the host can drain data from the hard drive and stores the drained data on one or more second hard drives in the same server or a different server. The heat-responsive operation change is to select an alternative host other than the host that is predicted to experience temperatures above the threshold at the future time.

Similarly, I/O requests can be directed to different hosts that contain a redundant copy of the data (for a read I/O operation) or that have room to store additional data (for a write I/O operation).

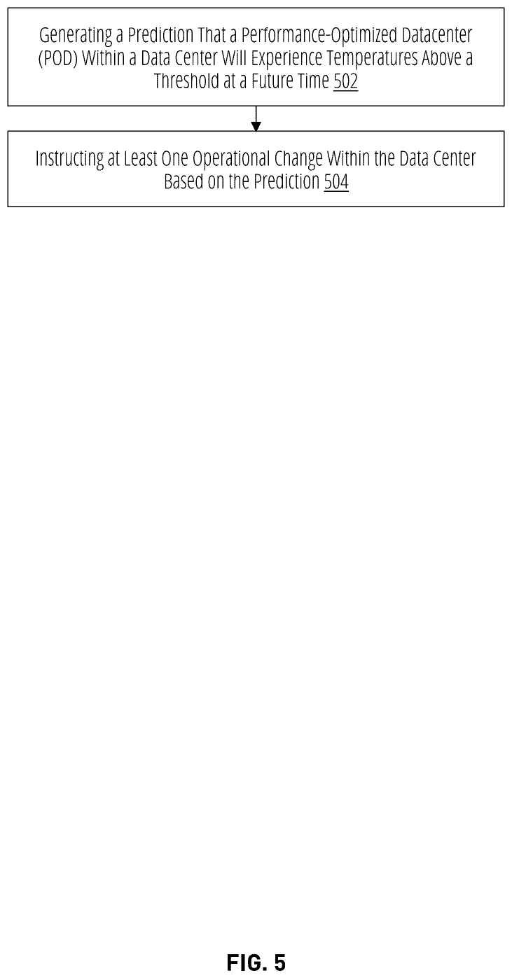

FIG. 5 illustrates an example routine for causing at least one operational change in a data center in response to a prediction that a POD will experience temperatures above a threshold in accordance with some embodiments of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

While the method illustrated in FIG. 3 pertained to a predicted temperature for a server or even a particular hard drive within a server, the method illustrated in FIG. 5 can use the same predictive thermal model to predict the temperature of a POD, which can contain a number of servers.

According to some examples, the method includes generating a prediction that a performance-optimized datacenter (POD) within a data center will experience temperatures above a threshold at a future time at block 502. For example, the predictive thermal model 168 illustrated in FIG. 1 may generate a prediction that a performance-optimized datacenter (POD) within a data center will experience temperatures above a threshold at a future time.

According to some examples, the method includes instructing at least one operational change within the data center based on the prediction at block 504. For example, the tenant data center controller 218 illustrated in FIG. 2 may instruct at least one operational change within the data center based on the prediction.

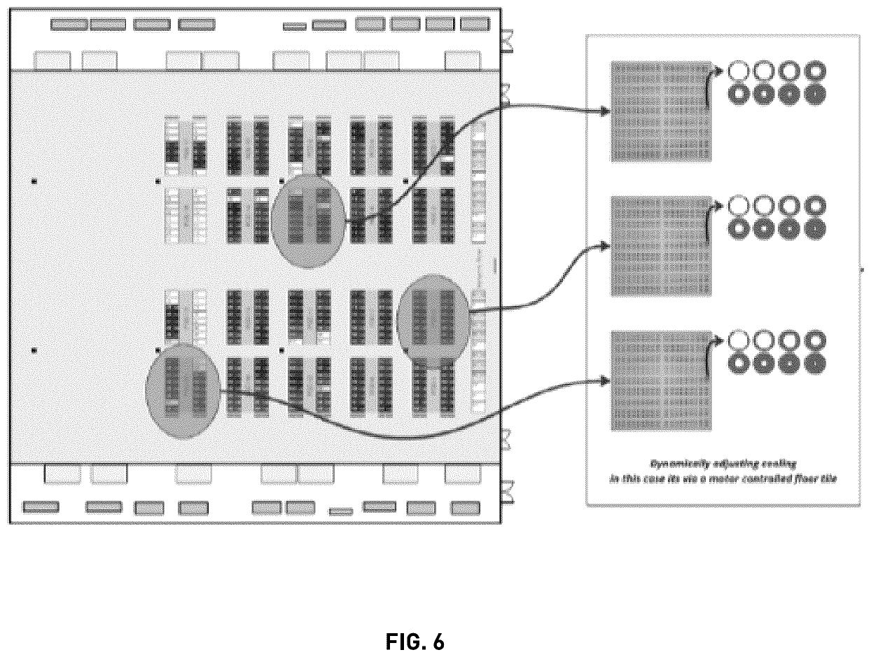

In some embodiments, and as illustrated in FIG. 6, the at least one operational change is to control a vent to increase its aperture to direct additional cold air into the POD. Vents in the floors of data centers, known as perforated floor tiles or adjustable vents, play a role in controlling airflow and maintaining optimal temperatures. These vents can be adjusted to direct cool air from the raised floor plenum, where chilled air is supplied, to specific areas requiring cooling, such as server racks and other heat-generating equipment. By fine-tuning the airflow, data center managers can ensure efficient cooling, reduce hotspots, and enhance the overall energy efficiency of the cooling system. This adjustability helps maintain a stable and controlled environment, which is essential for the reliable operation of sensitive data center equipment.

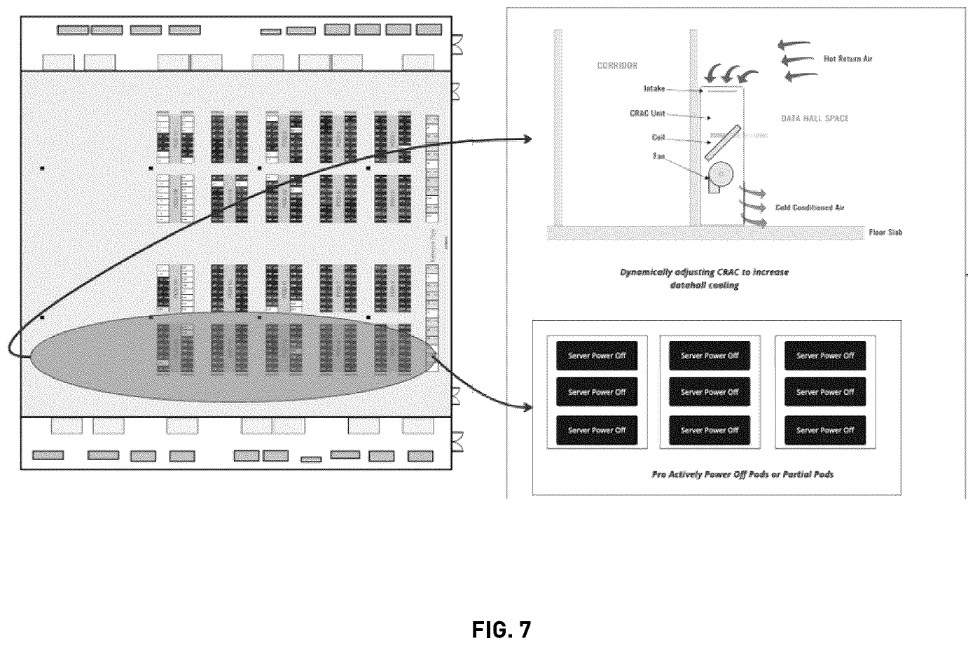

In some embodiments, and as illustrated in FIG. 7, the at least one operational change is to control a datacenter computer room air conditioner unit (CRAC) to shift airflow to cool the POD.

In some embodiments, the at least one operational change is to re-direct liquid cooling flow toward the POD to cool the POD.

In some embodiments, the at least one operational change is to power down or place into a “deep sleep” mode at least one server within the POD within the data center that will experience the temperatures above the threshold.

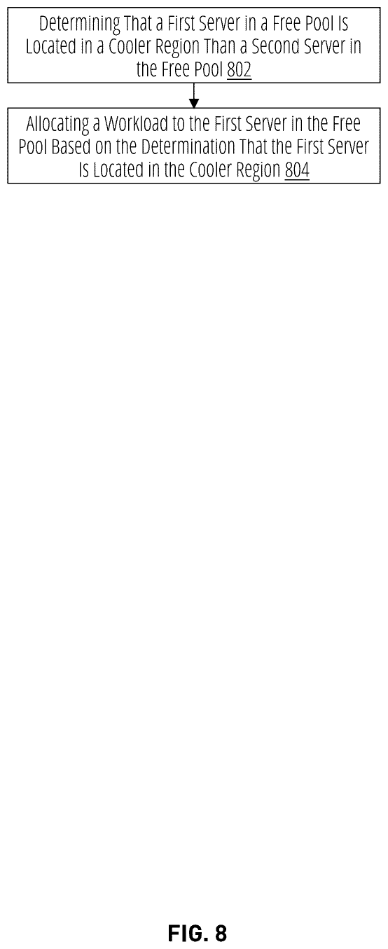

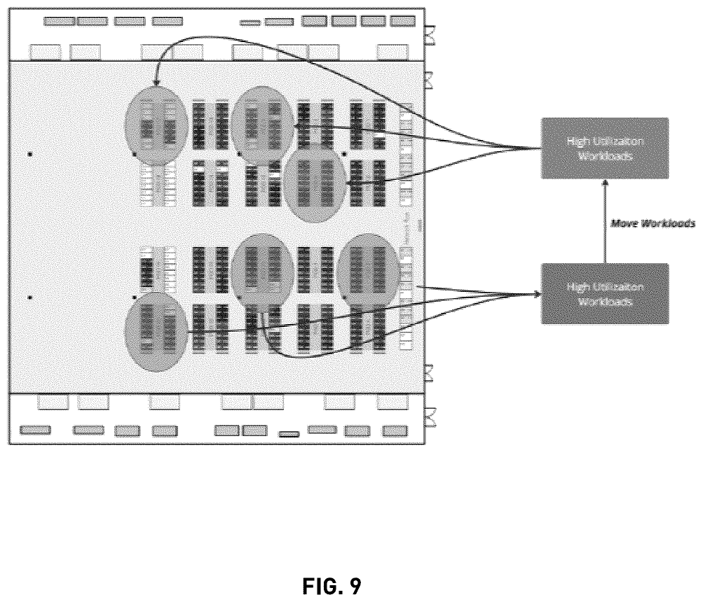

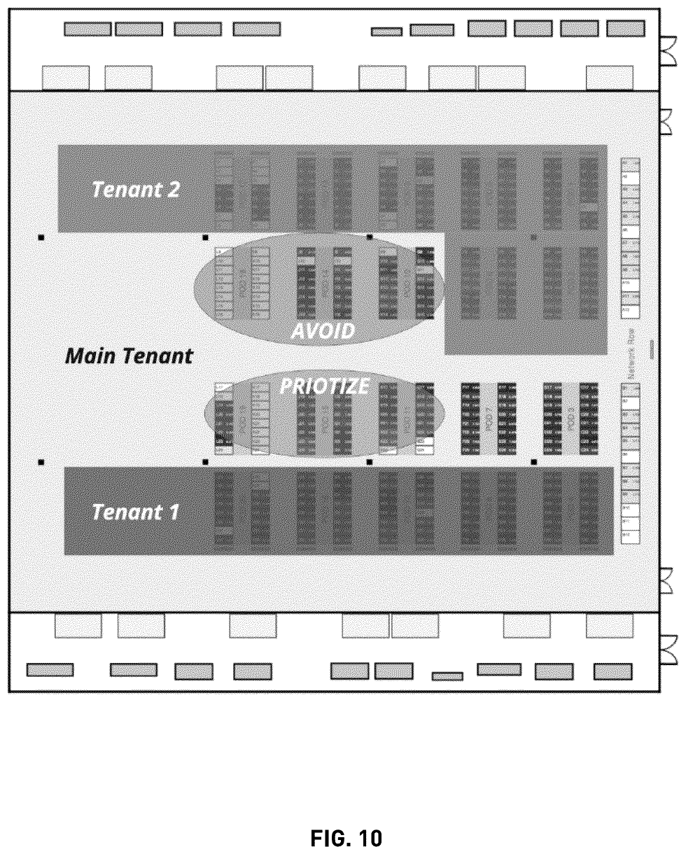

In some embodiments, the at least one operational change is to direct workloads away from at least one server within the POD that is predicted to be hot, to at least one server in a second POD that is predicted to be cool. This embodiment is addressed further with respect to FIG. 8, FIG. 9, and FIG. 10.

In some embodiments, the predictive thermal model 168 is a tenant-specific model, and therefore, the operational changes that can be made are subject to those that the tenant can request or control. In some data centers, it is possible for a tenant to request a CRAC to provide additional cooling, but in some data centers the CRAC might not be under the control of the tenant such that requests for additional cooling are either not possible or responding to such requests is subject to the needs of other tenants in the data center. However, operational changes such as controlling floor vent apertures, shifting workloads, and putting servers within a POD or the whole POD into a deep sleep state are likely to be within the control of the tenant.

In some embodiments, the method addressed with respect to FIG. 5 can be combined with the method addressed with respect to FIG. 3.

FIG. 8 illustrates an example routine for directing workloads away from at least one server within the POD that is predicted to be hot, to at least one server in a second POD that is predicted to be cool in accordance with some aspects of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes determining that a first server in a free pool (i.e. a pool of servers waiting to allocate a workload) is located in a cooler region than a second server in the free pool at block 802. For example, the tenant data center controller 218 illustrated in FIG. 2 may determine that a first server in a free pool is located in a cooler region than a second server in the free pool. The tenant data center controller 218 can learn this information from predictions received from predictive thermal model 168. In some embodiments, the server that is predicted to be hot is not necessarily hot at the time of the prediction but will be hot at some relevant, future period.

According to some examples, the method includes allocating a workload to the first server in the free pool based on the determination that the first server is located in the cooler region at block 804. For example, the tenant data center controller 218 illustrated in FIG. 2 may allocate a workload to the first server in the free pool based on the determination that the first server is located in the cooler region.

FIG. 9 graphically illustrates the operational change that moves a workload from a server that is hot or a server in a POD that is hot, to a cooler server or a server in a cooler POD.

In some instances, the data center might be shared with multiple tenants. In embodiments wherein the predictive thermal model is a tenant-specific predictive thermal model, the predictive thermal model can learn to infer that some PODs are likely located next to PODs of another tenant, which might tend to generate more heat than is desired. The predictive thermal model can learn the expected temperature of a server based on server workloads and the tenant servers near the server, and observe that the server is often hotter than predicted, which indicates a source of heat unknown to the predictive thermal model, and thereby infer that that server is proximate to servers of another tenant generating higher than normal amount of heat. In some instances, the predictive thermal model might also identify times of day when the server is hotter than expected which can indicate that the proximate tenant servers have regular cyclic periods of generating heat.

A decision to avoid placing workloads near a tenant generating a lot of heat can be based on more factors than temperature. For example, in addition to generating more heat, Tenant 2 might be expected to consume more cooling capability and add more stress on the power delivery in that row. Therefore, the tenant data center controller might want to direct critical workloads away from servers near the tenant generating more heat, consuming more cooling capacity, and/or consuming more power.

FIG. 10 illustrates that the tenant-specific predictive thermal model has predicted that a first server is located near servers utilized by another tenant (Tenant 2) of the data center, which generates higher than average amounts of heat. The tenant data center controller 218 can selectively place a workload at a second server (near Tenant 1 of the data center).

In some embodiments, the method addressed with respect to FIG. 8 can be combined with the method addressed with respect to FIG. 3 and/or FIG. 5.

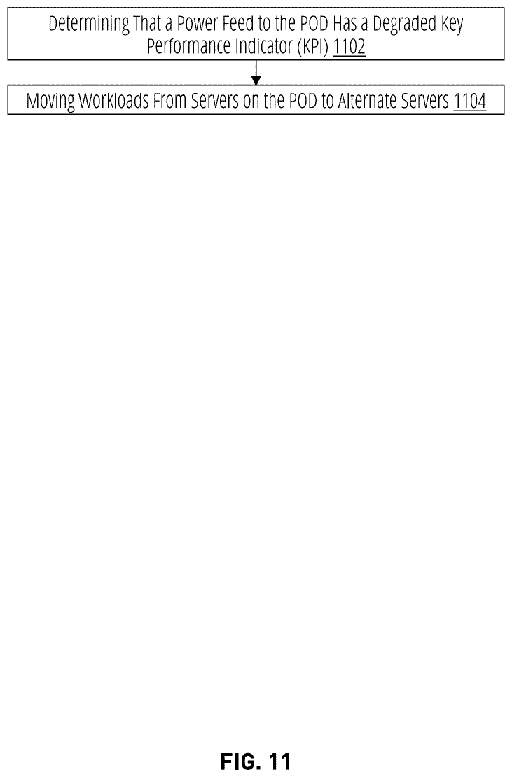

FIG. 11 illustrates an example routine for reallocating workloads away from servers having degraded power key performance indicator (KPI) or cooling KPI in accordance with some embodiments of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

While most of the present description has addressed temperature, this is but one relevant KPI. FIG. 11 provides a method of reallocating workloads based on a power KPI or a cooling KPI.

According to some examples, the method includes determining that a power feed to the POD has a degraded KPI or a cooling KPI is degraded at block 1102. For example, the tenant data center controller 218 illustrated in FIG. 2 may determine that a power feed to the POD or cooling to the POD has a degraded KPI. The KPI is that one of the redundant power feeds has gone down or that a measure of power waveforms is below a threshold, or that a cooling flow rate (liquid or air cooling) has decreased below a threshold or the temperature of the coolant (liquid or air) is too high. In some embodiments, the thresholds can be variable based on temperature of the PODs or power needs of the PODs.

According to some examples, the method includes moving workloads from servers on the POD to alternate servers at block 1104. For example, the tenant data center controller 218 illustrated in FIG. 2 may move workloads from servers on the POD to alternate servers. In this way, workloads are moved away from servers that might be prone to power surges or power failures or PODs that might be prone to insufficient cooling.

In some embodiments, the method addressed with respect to FIG. 11 can be combined with the method addressed with respect to FIG. 3, FIG. 5 and/or FIG. 8.

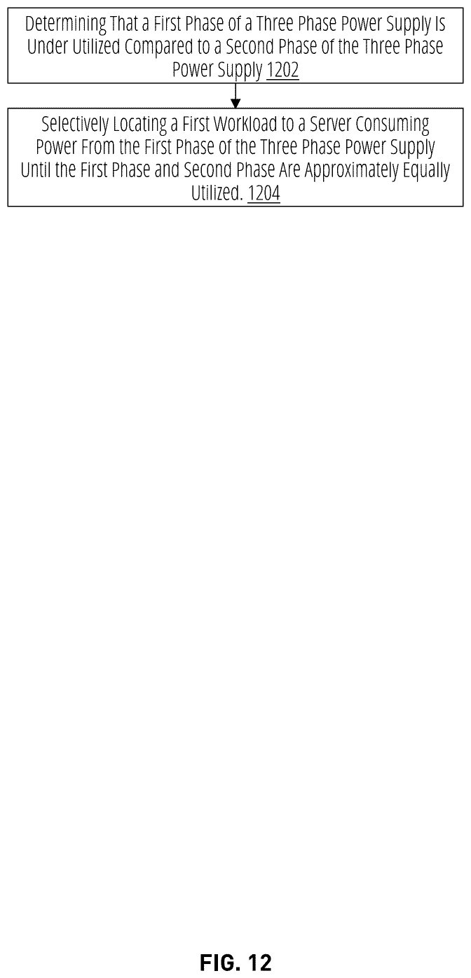

FIG. 12 illustrates an example routine for allocating workloads to make more efficient use of a power supply in accordance with some embodiments of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes determining that a first phase of a three-phase power supply is underutilized compared to a second phase of the three-phase power supply at block 1202. For example, the tenant data center controller 218 illustrated in FIG. 2 may determine that the first phase of a three-phase power supply is underutilized compared to a second phase of the three-phase power supply.

According to some examples, the method includes selectively locating a first workload to a server consuming power from the first phase of the three-phase power supply until the first phase, second phase, and third phase are approximately equally utilized (or at least more balanced) at block 1204. For example, the tenant data center controller 218 illustrated in FIG. 2 may selectively locate a first workload to a server consuming power from the first phase of the three-phase power supply until the first phase and second phase are approximately equally utilized.

In some embodiments, the method addressed with respect to FIG. 12 can be combined with the method addressed with respect to FIG. 3, FIG. 5, FIG. 8 and/or FIG. 11.

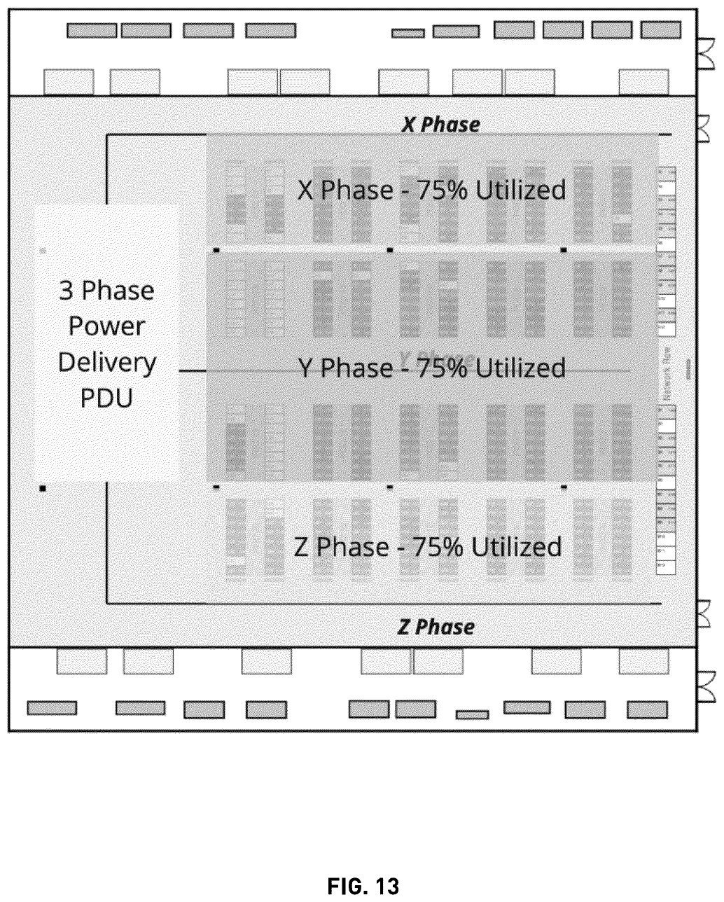

FIG. 13 illustrates an example of even utilization of a three-phase power supply in accordance with some embodiments of the present technology.

A three-phase power supply in a data center provides a reliable and efficient way to distribute electricity, minimizing the risk of power interruptions and ensuring stable operations. It delivers power through three alternating currents, each phase offset by 120 degrees, which balances the load and reduces the overall electrical stress on the system. Each phase can be used to power different equipment, or all three phases can be used to power the same equipment. This setup allows for the use of smaller and less expensive wiring and equipment while supplying a higher power density. In a data center, three-phase power is used to power critical infrastructure, such as servers, cooling systems, and networking equipment, ensuring that the high energy demands are met consistently and efficiently.

As illustrated in FIG. 13, phases X, Y, and Z are powering different PODs, and the present technology has caused the tenant data center controller to allocate workloads to servers in PODs so that all three phases as equally consumed. By distributing the load across different phases, you can balance the electrical demand more evenly, which helps prevent overloading any single phase and improves overall power efficiency and stability. Each POD can be connected to one of the three phases, allowing for a more efficient distribution of power and reducing the risk of power imbalances that could potentially cause operational issues.

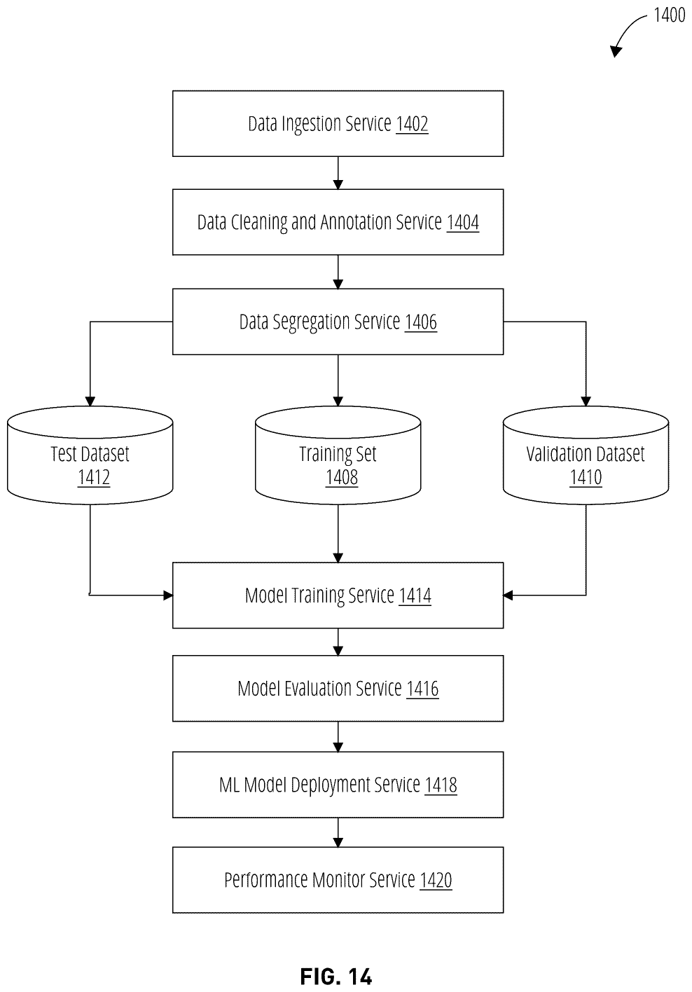

FIG. 14 illustrates an example lifecycle 1400 of a ML model in accordance with some examples—such as training of predictive thermal model 168. The first stage of the lifecycle 1400 of a ML model is a data ingestion service 1402 to generate datasets described below. ML models require a significant amount of data for the various processes described in FIG. 14 and the data persisted without undertaking any transformation to have an immutable record of the original dataset. The data can be provided from third party sources such as publicly available dedicated datasets. The data ingestion service 1402 provides a service that allows for efficient querying and end-to-end data lineage and traceability based on a dedicated pipeline for each dataset, data partitioning to take advantage of the multiple servers or cores, and spreading the data across multiple pipelines to reduce the overall time to reduce data retrieval functions.

In some cases, the data may be retrieved offline that decouples the producer of the data from the consumer of the data (e.g., an ML model training pipeline). For offline data production, when source data is available from the producer, the producer publishes a message and the data ingestion service 1402 retrieves the data. In some examples, the data ingestion service 1402 may be online and the data is streamed from the producer in real-time for storage in the data ingestion service 1402.

After data ingestion service 1402, a data preprocessing service preprocesses the data to prepare the data for use in the lifecycle 1400 and includes at least data cleaning, data transformation, and data selection operations. The data cleaning and annotation service 1404 removes irrelevant data (data cleaning) and general preprocessing to transform the data into a usable form. The data cleaning and annotation service 1404 includes labelling of features relevant to the ML model. In some examples, the data cleaning and annotation service 1404 may be a semi-supervised process performed by a ML to clean and annotate data that is complemented with manual operations such as labeling of error scenarios, identification of untrained features, etc.

After the data cleaning and annotation service 1404, data segregation service 1406 to separate data into at least a training set 1408, a validation dataset 1410, and a test dataset 1412. Each of the training set 1408, a validation dataset 1410, and a test dataset 1412 are distinct and do not include any common data to ensure that evaluation of the ML model is isolated from the training of the ML model.

The training set 1408 is provided to a model training service 1414 that uses a supervisor to perform the training, or the initial fitting of parameters (e.g., weights of connections between neurons in artificial neural networks) of the ML model. The model training service 1414 trains the ML model based a gradient descent or stochastic gradient descent to fit the ML model based on an input vector (or scalar) and a corresponding output vector (or scalar).

After training, the ML model is evaluated at a model evaluation service 1416 using data from the validation dataset 1410 and different evaluators to tune the hyperparameters of the ML model. The predictive performance of the ML model is evaluated based on predictions on the validation dataset 1410 and iteratively tunes the hyperparameters based on the different evaluators until a best fit for the ML model is identified. After the best fit is identified, the test dataset 1412, or holdout data set, is used as a final check to perform an unbiased measurement on the performance of the final ML model by the model evaluation service 1416. In some cases, the final dataset that is used for the final unbiased measurement can be referred to as the validation dataset and the dataset used for hyperparameter tuning can be referred to as the test dataset.

After the ML model has been evaluated by the model evaluation service 1416, an ML model deployment service 1418 can deploy the ML model into an application or a suitable device. The deployment can be into a further test environment such as a simulation environment, or into another controlled environment to further test the ML model.

After deployment by the ML model deployment service 1418, a performance monitor service 1420 monitors for performance of the ML model. In some cases, the performance monitor service 1420 can also record additional transaction data that can be ingested via the data ingestion service 1402 to provide further data, additional scenarios, and further enhance the training of ML models.

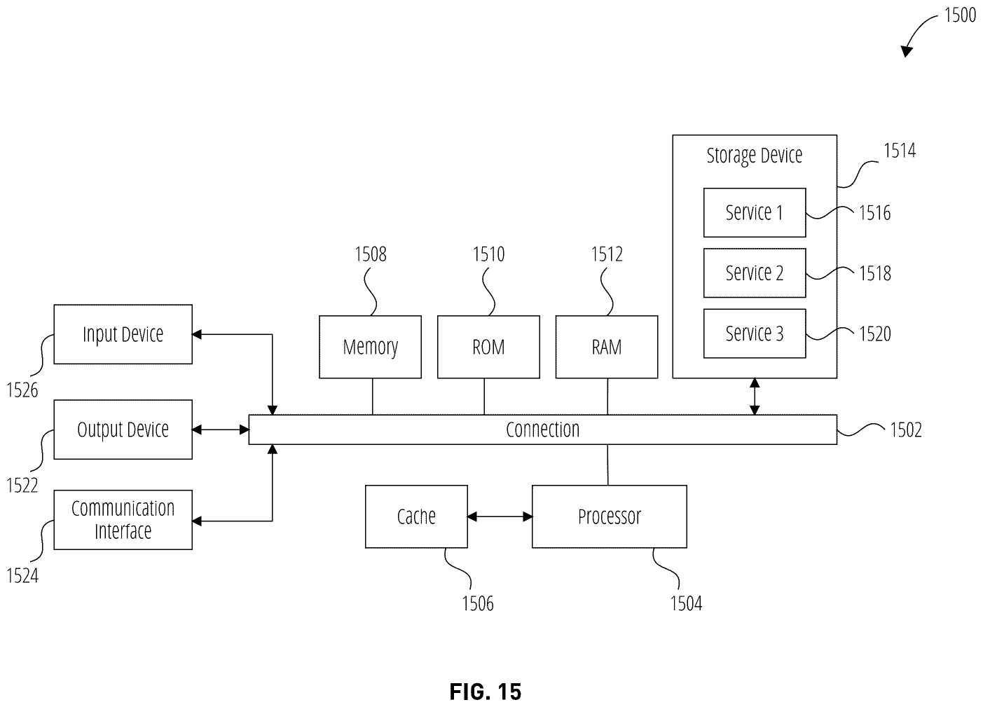

FIG. 15 shows an example of computing system 1500, which can be, for example, any computing device making up tenant data center controller 218, host 220, server 222, or any component thereof in which the components of the system are in communication with each other using connection 1502. Connection 1502 can be a physical connection via a bus, or a direct connection into processor 1504, such as in a chipset architecture. Connection 1502 can also be a virtual connection, networked connection, or logical connection.

In some embodiments, computing system 1500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 1500 includes at least one processing unit (CPU or processor) 1504 and connection 1502 that couples various system components including system memory 1508, such as read-only memory (ROM) 1510 and random access memory (RAM) 1512 to processor 1504. Computing system 1500 can include a cache of high-speed memory 1506 connected directly with, in close proximity to, or integrated as part of processor 1504.

Processor 1504 can include any general purpose processor and a hardware service or software service, such as services 1516, 1518, and 1520 stored in storage device 1514, configured to control processor 1504 as well as a special-purpose processor where software instructions are incorporated into the actual processor design. Processor 1504 may essentially be a completely self-contained computing system, containing multiple cores or processors, a bus, memory controller, cache, etc. A multi-core processor may be symmetric or asymmetric.

To enable user interaction, computing system 1500 includes an input device 1526, which can represent any number of input mechanisms, such as a microphone for speech, a touch-sensitive screen for gesture or graphical input, keyboard, mouse, motion input, speech, etc. Computing system 1500 can also include output device 1522, which can be one or more of a number of output mechanisms known to those of skill in the art. In some instances, multimodal systems can enable a user to provide multiple types of input/output to communicate with computing system 1500. Computing system 1500 can include communication interface 1524, which can generally govern and manage the user input and system output. There is no restriction on operating on any particular hardware arrangement, and therefore the basic features here may easily be substituted for improved hardware or firmware arrangements as they are developed.

Storage device 1514 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1514 can include software services, servers, services, etc., that when the code that defines such software is executed by the processor 1504, it causes the system to perform a function. In some embodiments, a hardware service that performs a particular function can include the software component stored in a computer-readable medium in connection with the necessary hardware components, such as processor 1504, connection 1502, output device 1522, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

### Aspects:

The present technology includes computer-readable storage mediums for storing instructions, and systems for executing any one of the methods embodied in the instructions addressed in the aspects of the present technology presented below:

Clause 1. A method comprising: generating, using a predictive thermal model, a prediction that a host operating at a first I/O operational mode will experience temperatures above a threshold at a future time; triggering a heat-responsive operation change in response to the prediction, wherein the heat-responsive operation change causes the host to operate a second I/O operational mode, wherein the second I/O operational mode generates less heat than the first I/O operational mode.

Clause 2. The method of clause 1, wherein the second I/O operational mode includes: batching, by the host, I/O requests for the host; and organizing, by the host, the I/O requests into sequential order, thereby the host performs less seek operations to handle the I/O requests than tfirst I/O operational state.

Clause 3. The method of clause 1, wherein the second I/O operational mode performs fewer seek operations per second than the first I/O operational mode.

Clause 4. The method of clause 1, wherein the predictive thermal model is trained to predict a temperature of the host within at least one server, wherein the future time is at least two future times, a first future time, and a second future time, wherein the first future time is less than a minute from the prediction, and the second future time is greater than a minute from the prediction.

Clause 5. The method of clause 4, wherein the predictive thermal model predicts a temperature 30 seconds, 1 minute, and 10 minutes into the future.

Clause 6. The method of clause 1, wherein the heat-responsive operation change drains data from the host and stores the drained data on one or more second hosts.

Clause 7. The method of clause 1, wherein the heat-responsive operation change is to select an alternative host other than the host that is predicted to experience temperatures above the threshold at the future time.

Clause 8. The method of clause 7, wherein a live write operation is directed to the host other than the host that is predicted to experience temperatures above the threshold at the future time.

Clause 9. The method of clause 7, wherein a live read operation is directed to the host other than the host when the other host contains a redundant copy of data.

Clause 10. The method of clause 8 or 9, wherein a live operation is one that pertains to accessing or modifying data that is actively being used or is available in real-time in the system.

Clause 11. A method comprising: generating, using a predictive thermal model, a prediction that a performance-optimized datacenter (POD) within a data center will experience temperatures above a threshold at a future time; instructing, by a tenant data center controller, at least one operational change within the data center based on the prediction.

Clause 12. The method of clause 11, wherein the at least one operational change is to control a vent to increase its aperture to direct additional cold air into the POD.

Clause 13. The method of clause 11, wherein the at least one operational change is to control a datacenter computer room air conditioner unit (CRAC) to shift airflow to cool the POD within the data center that will experience the temperatures above the threshold.

Clause 14. The method of clause 11, wherein the at least one operational change is to power down at least one server within the POD within the data center that will experience the temperatures above the threshold.

Clause 15. The method of clause 11, wherein the predictive thermal model predicts that a second POD within the data center will be cool at the future time, and the at least one operational change is to move workloads from at least one server within the POD, to at least one server in the second POD.

Clause 16. The method of clause 11, wherein the predictive thermal model is a tenant-specific predictive thermal model.

Clause 17. The method of clause 16, further comprising: predicting, by the tenant-specific predictive thermal model, that a first server is located near servers utilized by another tenant of the data center; selectively placing a workload at a second server, wherein the tenant-specific predictive thermal model has not predicted that the second server is near the servers utilized by another tenant of the data center.

Clause 18. The method of clause 11, further comprising: determining that a power feed to the POD has a degraded key performance indicator (KPI), wherein the KPI is that one of a redundant power feed has gone down, or that a measure of power waveforms is below a power threshold; moving workloads from servers on the POD to alternate servers.

Clause 19. The method of clause 11, further comprising: determining that a first phase of a three-phase power supply is underutilized compared to a second phase of the three-phase power supply; selectively locating a first workload to a server consuming power from the first phase of the three-phase power supply until the first phase and the second phase are approximately equally utilized.

Clause 20. The method of clause 11. further comprising: determining that a first server in a free pool is located in a cooler region than a second server in the free pool; allocating a workload to the first server in the free pool based on the determination that the first server is located in the cooler region.

What is claimed is:

1. A method comprising:
generating, using a predictive thermal model, a prediction that a host operating at a first I/O operational mode will experience temperatures above a threshold at a future time; and
triggering a heat-responsive operation change in response to the prediction, wherein the heat-responsive operation change causes the host to operate in a second I/O operational mode, wherein the second I/O operational mode generates less heat than the first I/O operational mode.

2. The method of claim 1, wherein the second I/O operational mode includes at least one of the following:
batching, by the host, I/O requests for the host; and
organizing, by the host, the I/O requests into sequential order, thereby the host performs less seek operations to handle the I/O requests than the first I/O operational state.

3. The method of claim 1, wherein the predictive thermal model is trained to predict a temperature of the host within at least one server, wherein the future time comprises at least two future times.

4. The method of claim 1, wherein the heat-responsive operation change drains data from the host and stores the drained data on one or more second hosts.

5. The method of claim 1, wherein the heat-responsive operation change comprises selecting an alternative host other than the host that is predicted to experience temperatures above the threshold at the future time.

6. A non-transitory computer-readable storage medium, the computer-readable storage medium including instructions that when executed by a computer, cause at least one processor to:
generate, using a predictive thermal model, a prediction that a performance-optimized datacenter (POD) within a data center will experience excessive temperatures at a future time; and
instruct, by a tenant data center controller, at least one operational change within the data center based on the prediction.

7. The non-transitory computer-readable storage medium of claim 6, wherein the at least one operational change is to control a vent to increase its aperture to direct additional cold air into the POD.

8. The non-transitory computer-readable storage medium of claim 6, wherein the at least one operational change is to control a datacenter computer room air conditioner unit (CRAC) to shift airflow to cool the POD within the data center that will experience the excessive temperatures.

9. The non-transitory computer-readable storage medium of claim 6, wherein the at least one operational change is to power down at least one server within the POD within the data center that will experience the excessive temperatures.

10. The non-transitory computer-readable storage medium of claim 6, wherein the predictive thermal model predicts that a second POD within the data center will be cool at the future time, and the at least one operational change is to move workloads from at least one server within the POD to at least one server in the second POD.

11. The non-transitory computer-readable storage medium of claim 6, wherein the predictive thermal model is a tenant-specific predictive thermal model.

12. The non-transitory computer-readable storage medium of claim 11, wherein the instructions further configure the at least one processor to:
predict, by the tenant-specific predictive thermal model, that a first server is located near servers utilized by another tenant of the data center;
selectively place a workload at a second server, wherein the tenant-specific predictive thermal model has not predicted that the second server is near the servers utilized by another tenant of the data center.

13. The non-transitory computer-readable storage medium of claim 6, wherein the instructions further configure the at least one processor to:
determine that a power feed to the POD has a degraded key performance indicator (KPI), wherein the KPI is that one of a redundant power feed has gone down, or that a measure of power waveforms is below a power threshold; and
move workloads from servers on the POD to alternate servers.

14. The non-transitory computer-readable storage medium of claim 6, wherein the instructions further configure the at least one processor to:
determine that a first phase of a three-phase power supply is underutilized compared to a second phase of the three-phase power supply;
selectively locate a first workload to a server consuming power from the first phase of the three-phase power supply until the first phase and the second phase are approximately equally utilized.

15. The non-transitory computer-readable storage medium of claim 6, wherein the instructions further configure the at least one processor to:
determine that a first server in a free pool is located in a cooler region than a second server in the free pool;
allocate a workload to the first server in the free pool based on the determination that the first server is located in the cooler region.

16. A computing system comprising:
computing system; and
a memory storing instructions that, when executed by the at least one processor, configure the computing system to:
generate, using a predictive thermal model, a prediction that a host operating at a first I/O operational mode will experience temperatures above a threshold at a future time;
trigger a heat-responsive operation change in response to the prediction, wherein the heat-responsive operation change causes the host to operate a second I/O operational mode, wherein the second I/O operational mode generates less heat than the first I/O operational mode.

17. The computing system of claim 16, wherein the second I/O operational mode includes at least one of the following:
batch, by the host, I/O requests for the host; and
organize, by the host, the I/O requests into sequential order, thereby the host performs less seek operations to handle the I/O requests than the first I/O operational state.

18. The computing system of claim 16, wherein the predictive thermal model is trained to predict a temperature of the host within at least one server, wherein the future time comprises at least two future times.

19. The computing system of claim 16, wherein the heat-responsive operation change drains data from the host and stores the drained data on one or more second hosts.

20. The computing system of claim 16, wherein the heat-responsive operation change comprises selecting an alternative host other than the host that is predicted to experience temperatures above the threshold at the future time.
